(19) United States
(12) Patent Application Publication
(10) Pub. No.: US 2006/0234122 A1
(43) Pub. Date: Oct. 19, 2006

(54) Button-type alkaline battery

(76) Inventors: Takeshi Shishido, Miyagi (JP); Tsugio Sakai, Miyagi (JP)

Correspondence Address: BRUCE L. ADAMS, ESQ., 17 BATTERY PLACE - SUITE 1231, NEW YORK, NY, 10004, US

(21) Appl. No.: 11/389,448

(22) Filed: Mar. 24, 2006

(30) Foreign Application Priority Data
Apr. 19, 2005 (JP) 2005-120699

(51) Int. Cl. H01M 4/58; H01M 4/42; H01M 4/50

(52) U.S. Cl. 429/218.2; 429/229; 429/224

(57) ABSTRACT

A button-type alkaline battery not causing increase of the pressure inside the battery and liquid leakage contains zinc or zinc alloy in the negative electrode and a hydrogen occluding alloy in the positive electrode.

### BACKGROUND OF THE INVENTION

### Field of the Invention

The present invention relates to a flat button-type alkaline battery.

In a button-type alkaline battery used for small-sized electronic equipments such as electronic wrist watches and portable electronic calculators, an open end of a positive electrode can is sealed by way of a gasket by a negative electrode can.

The negative electrode can is constructed by pressing a three-layered clad material of a nickel layer, a metal layer comprising a stainless steel (SUS), and a collector layer comprising copper into a cup-shape. For the negative electrode, amalgamated zinc formed by amalgamation of zinc or zinc alloy powder with mercury is used. Addition of mercury to the negative electrode suppresses evolution of a hydrogen gas inside an alkaline battery. A hydrogen gas evolves by contact of zinc or zinc alloy powder and an alkali electrolyte inside the battery. Further, the hydrogen gas evolves from a collector also by contact of zinc or zinc alloy powder with copper of a collector layer of the negative electrode can by way of the alkali electrolyte.

The reaction of evolving the hydrogen gas is a reaction that is taken place when zinc or zinc alloy powder is dissolved in an alkali electrolyte in which zinc is oxidized into zinc oxide. As a countermeasure, evolution of hydrogen has been suppressed by the use of amalgam zinc formed by mercury amalgamation. This can provide the effect of suppressing the lowering of capacity storability, lowering of liquid leakage proofness due to increase of the internal pressure, and swelling of the battery accompanied by hydrogen evolution, respectively.

### SUMMARY OF THE INVENTION

In recent years, suppression for the evolution of hydrogen not relying on the use of mercury has been demanded for avoiding the use of mercury as much as possible also in the button-type alkaline battery as the small-sized battery. However, those capable of suppress the evolution of the hydrogen gas easily and completely have not yet been found.

Particularly, since the button-type battery is extremely small and has no additional space, and the internal structure of the battery is different greatly, the method of moderating the internal pressure caused by the hydrogen gas adopted for cylindrical alkaline battery can not be applied as it is to a small-sized coin-type alkaline battery.

Further, the button-type alkaline battery has a structure that a gasket is placed on a positive electrode. In a case where the positive electrode is formed of silver oxide with addition of a predetermined amount of manganese dioxide, or manganese dioxide, the strength of the positive electrode mix is lowered compared with the case of using only the silver oxide as a positive electrode active substance and, upon sealing the battery, the outer periphery of the positive electrode mix supporting the gasket on the side of the negative electrode deforms to decrease the compression of the gasket and, as a result, the liquid leakage proofness of the battery may possibly be deteriorated.

With the reasons described above, coin-type and button-type alkali batteries containing manganese dioxide for the positive electrode and not containing mercury for the negative electrode have not yet been present in general market at present.

The invention intends to solve the problem efficiently and economically and provide an alkaline battery of high reliability.

The button-type alkaline battery according to the invention has a positive electrode containing a hydrogen occluding alloy, and a negative electrode containing zinc or zinc alloy.

The button alkaline battery of the invention has a positive electrode containing manganese dioxide and a hydrogen occluding alloy, a negative electrode containing zinc or zinc alloy, a positive electrode can to which the positive electrode is disposed, a negative electrode can to which the negative electrode is disposed, a gasket put between the positive electrode can and the negative electrode can, a separator for separating the positive electrode and the negative electrode, and an alkali electrolyte.

Preferably, the button-type alkaline battery of the invention has a positive electrode containing manganese dioxide and a hydrogen occluding alloy, a negative electrode containing zinc or zinc alloy, a positive electrode can to which the positive electrode is disposed, a negative electrode can to which the negative electrode is disposed, a gasket put between the positive electrode can and the negative electrode can, a separator for separating the positive electrode and the negative electrode, and an alkali electrolyte, wherein a hydrogen gas evolved inside the battery is occluded by the hydrogen occluding alloy.

More preferably, a button-type alkaline battery of the invention has a positive electrode containing manganese dioxide and a hydrogen occluding alloy, a negative electrode containing zinc or zinc alloy, a positive electrode can to which the positive electrode is disposed, a negative electrode can to which the negative electrode is disposed, a gasket put between the positive electrode can and the negative electrode can, a separator for separating the positive electrode and the negative electrode, and an alkali electrolyte, wherein the hydrogen gas evolved inside the battery is occluded by the hydrogen occluding alloy, to prevent increase of the pressure inside the battery.

According to the present invention, since the hydrogen occluding alloy powder is added to the positive electrode, the hydrogen gas evolved from the zinc or zinc alloy powder in the alkali electrolyte is absorbed effectively and, accordingly, lowering of the liquid leakage proofness or the electric characteristics caused by the evolution of the hydrogen gas can be suppressed sufficiently, as well as addition of the hydrogen occluding alloy powder to the positive electrode mix can significantly improve the moldability of the positive electrode mix and can keep compression of the gasket by suppressing the deformation for the outer periphery of the positive electrode mix for supporting the gasket on the side of the negative electrode thereby capable of suppressing the lowering of the liquid leakage proofness.

Then, the invention can provide an alkaline battery which is inexpensive and also excellent in the liquid leakage proofness not relying on the use of mercury.

### DESCRIPTION OF THE ACCOMPANYING DRAWINGS

FIG. 1 is a schematic cross sectional view showing an example of a preferred embodiment, of an alkaline battery according to the present invention; and

FIG. 2 is a cross sectional view of a negative electrode can of an alkaline battery according to the invention.

### PREFERRED EMBODIMENTS OF THE INVENTION

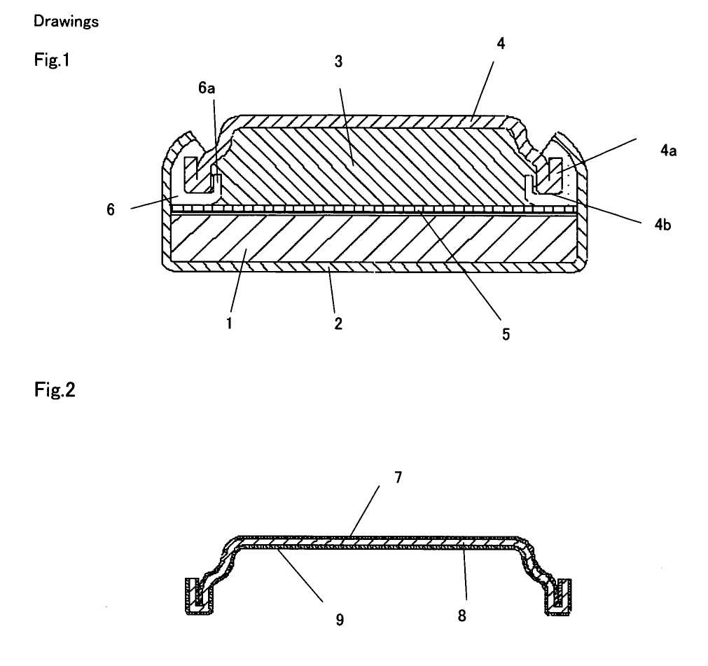

An alkaline battery according to the present invention is to be described with reference to FIG. 1. FIG. 1 is a schematic cross sectional view of a flat button-type alkaline battery. A negative electrode can 4 has a turn-back portion 4a turned-back along the outer peripheral surface in a U-cross sectional shape and a turn-back bottom 4b formed at the open end edge, which is clamped by the inner peripheral surface of the open end edge of the positive electrode can 2 by way of a gasket 6 at the turn-back portion 4a and kept under sealing.

The positive electrode can 2 has a structure in which nickel plating is applied to a stainless steel plate, which also serves as a positive electrode terminal. A positive electrode 1 comprising silver oxide with addition of manganese dioxide or manganese dioxide as a positive electrode active substance with addition of a hydrogen occluding alloy powder is molded as a coin type or button type pellet and contained and disposed inside the positive electrode can 2.

Then, a separator 5 is placed on the positive electrode 1 in the positive electrode can 2. The separator 5 has a three-layered structure of films formed by graft polymerizing, for example, non-woven fabric, cellophane and polyethylene. Then, the separator 5 is impregnated with an alkali electrolyte. An aqueous solution of sodium hydroxide, an aqueous solution of potassium hydroxide, or a mixed aqueous solution of an aqueous solution of sodium hydroxide and an aqueous solution of potassium hydroxide can be used, for example, as an alkali electrolyte.

In this embodiment, a ring-shaped cross sectional gasket 6 made, for example, of nylon is disposed to the inner peripheral surface of the open end edge of the positive electrode can 2. Then, a negative electrode 3 is disposed on the separator 5 in the cross sectional gasket 6. The negative electrode 3 is in the form of a mercury-free gel, that is a gel comprising mercury-free zinc or zinc alloy powder, an alkali electrolyte and a viscosity improver.

A negative electrode can 4 is inserted in the open end edge of the positive electrode can 2 so as to contain the negative electrode 3. The negative electrode can 4 is formed with a U-shaped turn-back portion 4a turned-back along the outer peripheral surface in a U-cross sectional shape and a turn-back bottom 4b to the open end edge thereof, which is clamped at the U-shaped turn back portion 4a by the inner peripheral surface of the open end edge of the positive can 2 by way of the cross sectional gasket 6 and held in a sealed state.

The positive electrode 1 can be press molded by a pelleting machine or the like after mixing a silver oxide with addition of a predetermined amount of manganese dioxide or manganese dioxide as a positive electrode active substance, graphite as a conductive agent, and a hydrogen occluding alloy powder. In addition, nickel oxyhydroxide, silver-nickel composite oxide, etc. are also preferred as the positive electrode active substance.

### EXAMPLE

The present invention is to be described further with reference to examples and comparative examples.

### Example 1

In this example, a battery of a structure shown in FIG. 1 was constructed. At first, as shown in FIG. 2, a U-shaped turn-back portion 4a and a turn-back bottom 4b were formed to the peripheral edge described in FIG. 2 by pressing a three-layered clad material of 0.2 mm thickness having three-layers of a nickel layer 7, a metal layer 8 formed of a stainless steel (SUS304), and a collector layer 9 formed of copper to prepare a negative electrode can 4 having the turn-back bottom 4b and the outer peripheral turn-back portion 4a.

On the other hand, an alkali electrolyte comprising 22 mass % of sodium hydroxide and 9 mass % of potassium hydroxide was poured and then the positive electrode 1 formed into a disk-shape was inserted into the positive electrode can 2 described above and the alkali electrolyte is absorbed to the positive electrode 1. The positive electrode 1 was molded into a pellet shape by mixing 86 mass % of silver oxide, 10 mass % of manganese dioxide, 3 mass % of graphite, and 1 mass % of an LaNi₅ type hydrogen occluding alloy of an average grain size of 20 μm with an equilibrium hydrogen pressure at 30° C. of 2.5 atm by a blender and then by molding the mixture by a pelleting machine.

A separator 5 of a three-layered structure of a film formed by graft polymerizing a non-woven fabric, cellophane and polyethylene and punching the film into a disk-like shape was loaded on the positive electrode 1, and an alkali electrolyte comprising 22 mass % of sodium hydroxide, and 9 mass % of potassium hydroxide was dropped and impregnated into the separator 5.

A gel-like negative electrode 3 comprising aluminum free of mercury, zinc alloy powder containing indium and bismuth, zinc oxide, viscosity improver, sodium hydroxide, potassium hydroxide, and water was placed on the separator 5, a negative electrode can 4 was inserted into the opening end edge of the positive electrode can 2 while covering the negative electrode 3 by way of a ring-shaped gasket 6 made of nylon formed by coating a sealant on 66 nylon, and the open end edge of the positive electrode can 2 was sealed by caulking to manufacture an alkaline battery. In this case, the outer periphery of the central protrusion 6a of the cross sectional gasket 6 is in contact with the inner surface of the negative electrode 4.

### Example 2

Example 2 had the same structure as in Example 1 excepting that the hydrogen occluding alloy powder added to the positive electrode 1 had an average grain size of 5 μm.

### Example 3

Example 3 had the same structure as in Example 1 excepting that the hydrogen occluding alloy powder added to the positive electrode 1 had an average grain size of 10 μm.

### Example 4

Example 4 had the same structure as in Example 1 excepting that the hydrogen occluding alloy powder added to the positive electrode 1 had an average grain size of 50 μm.

### Example 5

Example 5 had the same structure as in Example 1 excepting that the hydrogen occluding alloy powder added to the positive electrode 1 had an average grain size of 70 μm.

### Example b 6

Example 6 had the same structure as in Example 1 excepting that the mass ratio of the hydrogen occluding alloy powder added to the positive electrode 1 was 0.1 mass %.

### Example 7

Example 7 had the same structure as in Example 1 excepting that the mass ratio of the hydrogen occluding alloy powder added to the positive electrode 1 was 0.5 mass %.

### Example 8

Example 8 had the same structure as in Example 1 excepting that the mass ratio of the hydrogen occluding alloy powder added to the positive electrode 1 was 5 mass %.

### Example 9

Example 9 had the same structure as in Example 1 excepting that the mass ratio of the hydrogen occluding alloy powder added to the positive electrode 1 was 7 mass %.

### Example 10

Example 10 had the same structure as in Example 1 excepting that the hydrogen occluding alloy powder added to the positive electrode 1 was an Lm-Ni type (Lm: lanthanum-rich misch metal) with an equilibrium hydrogen pressure at 30° C. was 3.3 atm.

### Example 11

Example 11 had the same structure as in Example 1 excepting that the hydrogen occluding alloy powder added to the positive electrode 1 was CaNi₅ with an equilibrium hydrogen pressure at 30° C. of 0.5 atm.

### Comparative Example 1

Comparative Example 1 had the same construction as in Example 1 excepting that the positive electrode 1 contained no hydrogen occluding alloy.

For Examples 1 to 11 and Comparative Example 1 described above batteries were manufactured for each by the number of 210. The batteries each by the number of 100 were stored in a severe circumstance at a temperature of 40° C. and at a relative humidity of 90%. Table 1 shows the result for evaluation on the rate of occurrence of liquid leakage after 120 days and 140 days. Then, batteries each by the number of 100 were discharged at a constant resistance of 30 kΩ, and the discharge capacity (mAh) with the termination voltage defined as 1.2 V is shown in Table 1. Finally, the batteries each by the number of ten were put in a circumstance at a temperature of −10° C., and the closed circuit voltage (V) after 5 sec, at a load resistor of 2 kΩ in the initial stage (discharge depth: 0%) is shown in Table 1.

TABLE 1

| | | | | | | Rate of | | | |
|---|---|---|---|---|---|---|---|---|---|
| | | | | | | occurrence | | | |
| | | | | Equilibrium | | of liquid | | | Closed |
| | Average grain | | | hydrogen | | leakage | | | circuit |
| | size of | Mass ratio of | | pressure of | Type of | After | After | | voltage |
| | hydrogen | hydrogen | | hydrogen | hydrogen | 120 | 140 | Initial | discharge |
| | occluding alloy | occluding alloy | | occluding alloy | occluding alloy | days | days | capacity | depth 0% |
| Example 1 | 20 μm | 1 | mass % | 2.5 atm | LaNi-type | 0% | 0% | 28.5 mAh | 1.39 V |
| Example 2 | 5 μm | 1 | mass % | 2.5 atm | LaNi-type | 1% | 3% | 28.3 mAh | 1.38 V |
| Example 3 | 10 μm | 1 | mass % | 2.5 atm | LaNi-type | 0% | 0% | 28.2 mAh | 1.38 V |
| Example 4 | 50 μm | 1 | mass % | 2.5 atm | LaNi-type | 0% | 0% | 28.5 mAh | 1.39 V |
| Example 5 | 70 μm | 1 | mass % | 2.5 atm | LaNi-type | 1% | 2% | 282 mAh | 1.33 V |
| Example 6 | 20 μm | 0.1 | mass % | 2.5 atm | LaNi-type | 0% | 5% | 28.5 mAh | 1.31 V |
| Example 7 | 20 μm | 0.5 | mass % | 2.5 atm | LaNi-type | 0% | 0% | 28.4 mAh | 1.38 V |
| Example 8 | 20 μm | 5 | mass % | 2.5 atm | LaNi-type | 0% | 0% | 27.8 mAh | 1.37 V |
| Example 9 | 20 μm | 7 | mass % | 2.5 atm | LaNi-type | 0% | 0% | 26.5 mAh | 1.38 V |
| Example 10 | 20 μm | 1 | mass % | 3.3 atm | LmNi-type | 0% | 0% | 28.3 mAh | 1.39 V |
| Example 11 | 20 μm | 1 | mass % | 0.5 atm | CaNi-type | 0% | 2% | 28.3 mAh | 1.31 V |
| Comp. | — | 0 | mass % | — | — | 6% | 15% | 28.2 mAh | 1.28 V |
| Example 1 | | | | | | | | | |

At first, when comparing Examples 1 to 5 and Comparative Example 1 in view of Table 1, the rate of occurrence of liquid leakage was decreased greatly by adding the hydrogen occluding alloy to the positive electrode 1.

It is considered that increase of the pressure inside the batteries was moderated to decrease the rate of occurrence of liquid leakage since the hydrogen gas (H₂) evolving from zinc or zinc alloy powder and the hydrogen gas (H₂) evolving from the collector by the contact of the zinc or zinc alloy powder with copper in the collector layer 9 of the negative electrode can by way of the alkali electrolyte are occluded into the hydrogen occluding alloy.

Further, it can be seen that the rate of occurrence of liquid leakage can be decreased to 0% by controlling the average grain size of the hydrogen occluding alloy powder added to the positive electrode 1 from 10 to 50 μm, which is particularly preferred.

This is because the average grain size of less than 10 μm is excessively fine grains and can not improve the moldability of the positive electrode mix sufficiently and can not completely suppress the deformation at the outer periphery of the positive electrode mix that supports the gasket upon sealing the battery. Further, in a case where the average grain size exceeds 50 μm, the specific surface area is decreased to reduce the hydrogen absorption amount, and the hydrogen gas generated due to the contact of zinc or zinc alloy powder with the collector by way of the alkali electrolyte can not be absorbed completely.

In a case of using the hydrogen occluding alloy with an average grain size of from 10 to 50 μm, the alloy can occlude the hydrogen gas to prevent increase of the pressure inside the battery and, at the same time, improve the strength of the positive electrode 1, so that the deformation at the outer periphery of the positive electrode 1 that supports the gasket 6 can be prevented completely upon sealing the battery, and compression of the gasket put between the positive electrode and the positive electrode can, and the negative electrode can be kept, so that liquid leakage from the button-alkaline battery can be prevented.

Then, when comparing Example 1 and Examples 6 to 9 with Comparative Example 1 in view of Table 1, the rate of occurrence of liquid leakage was greatly decreased in Example 1 and Examples 6 to 9 in which the hydrogen occluding alloy was added to the positive electrode 1, compared with comparative Example 1.

Further, in Example 1 and Examples 7 to 9 in which the mass ratio of the hydrogen occluding alloy powder added to the positive electrode 1 was controlled to 0.5 mass % or more, liquid leakage did not occur at all.

However, while liquid leakage did not occur in Example 9, decrease of the initial capacity was observed. Therefore, with a view point of preventing the liquid leakage and the initial capacity, it has been found that the addition amount of the hydrogen occluding alloy powder added to the positive electrode 1 is, particularly preferably, from 0.5 to 5 mass % based on the positive electrode 1.

This is because the improvement for the moldability of the positive electrode mix by the addition of the hydrogen occluding alloy and the effect by the hydrogen absorption is sometimes insufficient in a case where the content of the hydrogen occluding alloy powder in the positive electrode mix is less than 0.5 mass %. Further, in a case where the content of the hydrogen occluding alloy exceeds 5 mass %, the ratio of the positive electrode active substance in the positive electrode mix has to be lowered by so much and necessary electric capacity can not sometimes be ensured.

Finally, when comparing Example 1, Example 10, and Example 11 with Comparative Example 1 in view of Table 1, it can be seen that the electric characteristics can be improved by using an LaNi₅ type or Lm-Ni type alloy with the equilibrium hydrogen pressure of 1 atm or more for the hydrogen occluding alloy powder to be added to the positive electrode 1, and it can be seen that the equilibrium hydrogen pressure at 30° C. is preferably 1 atm or higher as the hydrogen absorption characteristics of the hydrogen occluding alloy.

This is attributable to that the internal pressure of the battery increases by sealing the battery, and the internal pressure of the battery increases remarkably by the evolution of the hydrogen gas since the battery is a closed type battery. The circumstance in which the positive electrode mix is placed is at about 1 atm as a normal pressure before sealing the battery and it goes higher than 1 atm after sealing the battery. Accordingly, in a case where the equilibrium hydrogen pressure of the added hydrogen occluding alloy is 1 atm or higher, zinc or zinc alloy powder is brought into contact with copper of the collector layer of the negative electrode can by way of the alkali electrolyte, thereby absorbing the hydrogen evolving from the collector more efficiently.

According to the invention, since the hydrogen occluding alloy powder is added to the positive electrode mix using the silver oxide with addition of a predetermined amount of manganese dioxide or manganese dioxide as the positive electrode active substance, the hydrogen gas evolving from zinc or zinc alloy powder in the alkali electrolyte is absorbed effectively, so that lowering of the liquid leakage proofness or the electric characteristic caused by the evolution of the hydrogen gas can be suppressed sufficiently.

More preferably, by the addition of the hydrogen occluding alloy powder with an average grain size of 10 μm or more and 50 μm or less to the positive electrode mix, lowering of the liquid leakage proofness can be suppressed since the moldability of the positive electrode mix can be improved outstandingly and the deformation at the outer periphery of the positive electrode mix on the side of the negative electrode that supports the gasket 6 upon sealing the battery can be suppressed to keep the compression of the gasket.

Therefore, according to the invention, even in an alkaline battery in which the positive electrode active substance comprises silver oxide with addition of a predetermined amount of manganese dioxide or manganese dioxide, satisfactory battery characteristics can be obtained without using mercury.

The hydrogen occluding alloy powder added to the positive electrode active substance may be not only the La—Ni or Lm-Ni type but also a titanium or magnesium type single or composite alloy of high hydrogen absorbancy.

The button type alkaline battery of the invention is a disk-shaped alkaline battery such as of a coil-shape type.

Further, it will be apparent that the invention is not restricted to the embodiments described above but can adopt various other constitutions without departing the gist of the invention.

### DESCRIPTION OF REFERENCES

(1) positive electrode
(2) positive electrode can
(3) negative electrode
(4) negative electrode can.
(4a) turn-back portion
(4b) turn-back bottom
(5) separator
(6) gasket
(6a) central protrusion
(7) nickel layer
(8) metal layer
(9) collector layer

What is claimed is:

1. A button-type alkaline battery comprising a positive electrode containing a hydrogen occluding alloy, and a negative electrode containing zinc or zinc alloy.

2. A button-type alkaline battery comprising a positive electrode containing manganese dioxide and a hydrogen occluding alloy, a negative electrode containing zinc or zinc alloy, a positive electrode can in which the positive electrode is disposed, a negative electrode can in which the negative electrode is disposed, a gasket put between the positive electrode can and the negative electrode can, a separator for separating the positive electrode and the negative electrode, and an alkali electrolyte.

3. A button-type alkaline battery according to claim 1, wherein the average grain size of the hydrogen occluding alloy is 10 μm or more and 50 μm or less.

4. A button-type alkaline battery according to claim 2, wherein the average grain size of the hydrogen occluding alloy is 10 μm or more and 50 μm or less.

5. A button-type alkaline battery according to claim 1, wherein the content of the hydrogen occluding alloy is 0.5 mass % or more and 5 mass % or less based on the positive electrode.

6. A button-type alkaline battery according to claim 2, wherein the content of the hydrogen occluding alloy is 0.5 mass % or more and 5 mass % or less based on the positive electrode.

7. A button-type alkaline battery according to claim 3, wherein the content of the hydrogen occluding alloy is 0.5 mass % or more and 5 mass % or less based on the positive electrode.

8. A button-type alkaline battery according to claim 4, wherein the content of the hydrogen occluding alloy is 0.5 mass % or more and 5 mass % or less based on the positive electrode.

9. A button-type alkaline battery according to claim 1, wherein the equilibrium hydrogen pressure at 30° C. of the hydrogen occluding alloy is 1 atm or higher.

10. A button-type alkaline battery according to claim 2, wherein the equilibrium hydrogen pressure at 30° C. of the hydrogen occluding alloy is 1 atm or higher.

11. A button-type alkaline battery according to claim 6, wherein the equilibrium hydrogen pressure at 30° C. of the hydrogen occluding alloy is 1 atm or higher.

12. A button-type alkaline battery according to claim 8, wherein the equilibrium hydrogen pressure at 30° C. of the hydrogen occluding alloy is 1 atm or higher.

13. A button-type alkaline battery comprising a positive electrode containing manganese dioxide and a hydrogen occluding alloy, a negative electrode containing zinc or zinc alloy, a positive electrode can in which the positive electrode is disposed, a negative electrode can in which the negative electrode is disposed, a gasket put between the positive electrode can and the negative electrode can, a separator for separating the positive electrode and the negative electrode, and an alkali electrolyte, wherein a hydrogen gas evolved inside the battery is occluded by the hydrogen occluding alloy.

14. A button-type alkaline battery comprising a positive electrode containing manganese dioxide and a hydrogen occluding alloy, a negative electrode containing zinc or zinc alloy, a positive electrode can in which the positive electrode is disposed, a negative electrode can in which the negative electrode is disposed, a gasket put between the positive electrode can and the negative electrode can, a separator for separating the positive electrode and the negative electrode, and an alkali electrolyte, wherein a hydrogen gas evolved inside the battery is occluded by the hydrogen occluding alloy, thereby preventing increase of the pressure inside the battery.
